(19) United States
(12) Patent Application Publication
(10) Pub. No.: US 2024/0370603 A1
(43) Pub. Date: Nov. 7, 2024

(54) SYSTEMS AND METHODS FOR CONTROLLING THE OPERATION OF A CO-SIMULATOR

(71) Applicant: Kabushiki Kaisha Toshiba, Tokyo (JP)

(72) Inventor: Magnus Stig Torsten SANDELL, Bristol (GB)

(73) Assignee: Kabushiki Kaisha Toshiba, Tokyo (JP)

(21) Appl. No.: 18/310,863

(22) Filed: May 2, 2023

(51) Int. Cl. G06F 30/20

(52) U.S. Cl. CPC G06F 30/20; G06F 2113/06

(57) ABSTRACT

A system for controlling the operation of a co-simulator comprising two or more sub-simulators, each sub-simulator being configured to simulate the behaviour of a respective sub-system of a second system, the co-simulator being configured to perform one or more iterations of a simulation in which the output of the sub-simulators is combined to determine a value of one or more properties of the second system, the system comprising: a controller configured to receive, at one or more time points during each iteration of the simulation, results of intermediate calculations performed by one or more of the sub-simulators, and to coordinate the input of the received results into other(s) of the sub-simulators for use in subsequent calculations to be performed during the course of the iteration; and an optimiser configured to determine, at each of the one or more time points and based on the results of the intermediate calculations, one or more elements of the co-simulator to adjust so as to optimise the process of determining the value of the one or more properties of the second system.

### FIELD

Embodiments described herein relate to systems and methods for controlling the operation of a co-simulator comprising two or more sub-simulators.

### BACKGROUND

Conventionally reduced order models, including simple look-up tables, are often used for the simulation of complex systems with multiple sub-systems. While such an approach can give results in a reasonably short time, it cannot identify and investigate certain transient effects or obtain accurate overall system performance. Therefore, in order to maximize the quality of the results of the system simulation, it is essential to use a model which is as detailed as possible.

As a result of the above, there is increasingly a trend towards a coupled simulation structure, or co-simulation. Co-simulation refers to the joint simulation of loosely coupled stand-alone sub-simulators, which may be used to model or simulate different subsystems of an overall larger system, often in different environments. Several products now offer the support for this kind of system simulation as there are many applications in, e.g., the automotive and aerospace industry.

In implementing a co-simulation, a data flow between each model is realised using a defined structure which allows the co-simulator to control the overall simulation of the whole system. A co-simulation algorithm takes care of time synchronization and interactions across the sub-simulators. The sub-simulators are assumed to be completely independent of each other between communication points enforced by the co-simulation controller. The sub-simulators may use different software or simulation approaches, and operate in different simulation domains, such as electromagnetism, thermal, or mechanical.

The sub-simulators behave conceptually like black boxes and accept inputs from other sub-simulators, advance in time with a built-in solver routine until the next communication point, and finally output results. These results may in turn be used again as inputs to other sub-simulators.

Although co-simulations can provide useful information about how well a system is likely to perform given a particular set of input values and parameters, it can be difficult to use the co-simulation to optimise the performance of that system. Conventionally, the individual sub-systems are optimised independently of one another, without taking into account how changes in input values and parameters of one sub-simulator may affect the performance of another sub-simulator. In other methods, a global approach may be used in which the final output from the co-simulation is fed into an optimisation algorithm. Such a global optimisation may, however, fail to take into account constraints imposed by the individual sub-systems, and lead to sub-optimal outputs from individual parts of the system.

### BRIEF DESCRIPTION OF THE DRAWINGS

Embodiments will now be described by way of example with reference to the accompanying drawings in which:

FIG. 1 shows an example structure of a conventional co-simulator;

FIG. 2 shows an example sequence of operations carried out by the co-simulator of FIG. 1;

FIG. 3 shows the structure of a co-simulator according to an embodiment;

FIG. 4 shows an example sequence of operations carried out by the co-simulator of FIG. 3;

FIG. 5 shows schematics of different types of floating structures for an offshore wind turbine;

FIG. 6 shows a plurality of blade control parameters that may be adjusted in order to optimise the power output from the turbines shown in FIG. 5;

FIG. 7 shows a schematic of a co-simulator for use in simulating the function of a wind turbine according to an embodiment; and

FIG. 8 shows a table comparing the properties of different types of optimisation algorithms for use in embodiments described herein.

### DETAILED DESCRIPTION

According to a first embodiment, there is provided a system for controlling the operation of a co-simulator comprising two or more sub-simulators, each sub-simulator being configured to simulate the behaviour of a respective sub-system of a second system, the co-simulator being configured to perform one or more iterations of a simulation in which the output of the sub-simulators is combined to determine a value of one or more properties of the second system, the system comprising:
a controller configured to receive, at one or more time points during each iteration of the simulation, results of intermediate calculations performed by one or more of the sub-simulators, and to coordinate the input of the received results into other(s) of the sub-simulators for use in subsequent calculations to be performed during the course of the iteration; and
an optimiser configured to determine, at each of the one or more time points and based on the results of the intermediate calculations, one or more elements of the co-simulator to adjust so as to optimise the process of determining the value of the one or more properties of the second system.

The one or more sub-simulators may simulate the behaviour of the respective sub-systems by executing respective models. The one or more elements of the co-simulator may comprise one or more parameters of at least one of the models.

The optimiser may be configured to adjust the parameters of at least one of the models, such that the model can be executed more quickly by the respective sub-simulator.

The one or more elements of the co-simulator may comprise an interval at which the intermediate results are output to the controller by the one or more sub-simulators.

The optimiser may be configured to abort a current iteration of the simulation based on determining that one or more of the intermediate results lie outside a predetermined range of values.

The value of one or more properties of the second system may comprise a measure of performance of the second system.

In some embodiments, for each iteration of the simulation, the two or sub-simulators may be provided with one or more input values; and the optimiser may be configured to determine, based on the estimated value of the one or more properties of the second system, a revised set of input values to use in the next iteration.

The revised set of input values may be determined using an optimisation algorithm, the optimisation algorithm being such as to determine a set of input values that result in an optimal value for the one or more properties of the second system.

The co-simulator may be configured to determine values of two or more properties of the second system. The optimisation algorithm may be selected so as to determine a set of input values that will jointly optimise the values of the two or more properties of the second system.

The optimiser may be configured to switch to using an alternative optimisation algorithm during the course of the co-simulator performing multiple iterations of the simulation.

The optimiser may be configured to switch to using the alternative optimisation algorithm in response to adjusting the one or more elements of the co-simulator.

Upon switching to using the alternative optimisation algorithm, the optimiser may be configured to retain, as input for the next iteration of the simulation, the set of input values determined in the latest iteration of the simulation.

The optimisation algorithm may be selected based on one or more properties of at least one of the two or more sub-simulators.

The one or more sub-simulators simulate the behaviour of the respective sub-systems by executing respective models. The one or more elements of the co-simulator may comprise one or more parameters of at least one of the models. The optimisation algorithm may be selected based on the one or more parameters.

The optimisation algorithm may be selected based on an accuracy or noise level associated with one or more of the sub-simulators.

The accuracy of each sub-simulator may be defined based on a difference between results of calculations for variables output by the sub-simulator and expected values for the variables in the real world.

The optimisation algorithm may be selected based on a memory requirement of the one or more of the sub-simulators.

The second system may be a windmill or wind turbine.

According to a second embodiment, there is provided a method for managing the operation of a co-simulator comprising two or more sub-simulators, each sub-simulator being configured to simulate the behaviour of a respective sub-system of a system, the co-simulator being configured to perform one or more iterations of a simulation in which the output of the sub-simulators is combined to determine a value of one or more properties of the system, the method comprising:
receiving, at one or more time points during each iteration of the simulation, results of intermediate calculations performed by one or more of the sub-simulators;
coordinating the input of the received results into other(s) of the sub-simulators for use in subsequent calculations to be performed during the course of the iteration; and
determining, at each of the one or more time points and based on the results of the intermediate calculations, one or more elements of the co-simulator to adjust so as to optimise the process of determining the value of the one or more properties of the system.

According to a third embodiment, there is a provided a non-transitory computer-readable storage medium comprising computer executable instructions that when executed by a computer will cause the computer to carry out a method according to the second embodiment.

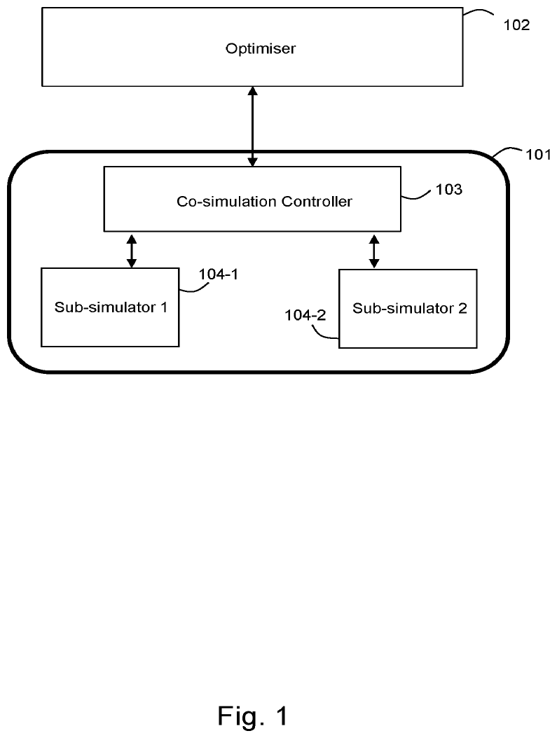

FIG. 1 shows the structure of a conventional co-simulator 101. The co-simulator 101 comprises multiple sub-simulators 104 and a co-simulation controller 103. In this example, the co-simulator includes two sub-simulators 104-1 and 104-2, but in general the co-simulator may possess any number of sub-simulators, depending on the complexity of the system to be modelled and the number of sub-systems for which simulation is required.

The sub-simulators 104 may be entirely software-based and be comprised of two main components: a model and a solver. The model generally comprises one or more variables that represent properties of the particular sub-system being simulated. These variables may include ones that represent physical properties of the sub-system, such as the physical dimensions or weight of components; operating parameters of the sub-system, such as input power; and environmental conditions in which the system is operating, such as temperature, wind-speed, pressure etc. The model may include one or more mathematical equations that can be solved by the solver in order to model how changes in each variable affect the overall output of the sub-system. In some examples, the model may be used to determine how particular variables change over time.

In some examples, the model for a particular sub-simulator may include one or more ordinary differential equations or partial differential equations, the solutions to which are determined iteratively using a numerical integration algorithm, for example. In such cases, the solver may be configured to execute the algorithm for a pre-defined number of iterations, or until the output from the model reaches a point beyond which it ceases to converge any further.

The sub-simulators 104-1, 104-2 are loosely coupled to one another by communicating with co-simulation controller 103. The co-simulation controller 103 synchronizes the co-simulation 101 by enforcing communication points between the sub-simulators 104-1, 104-2. At each communication point, one or more of the sub-simulators 104-1, 104-2 returns values of one or more variables to the co-simulation controller. The co-simulation controller 103 may then communicate those output values to a different one of the sub-simulators 104-1, 104-2, to use as an input value in subsequent calculations. This process may repeat for a defined number of times, with the sub-simulators exchanging results of their computations at a plurality of time intervals, before the co-simulation arrives at its final output. The results exchanged at each communication point can be considered as being “intermediate results” in that they are computed by the respective sub-simulators during the course of an individual iteration of the co-simulation, and are used for determining the final output of the co-simulation for that particular iteration.

The final output from the co-simulator may itself specify a value for one or more properties of the system being simulated. For example, the final output may comprise an estimate of how well the system is likely to perform under certain conditions. Having obtained the final output for a particular iteration of the co-simulation, the co-simulation may be re-run over one or more successive iterations, with the sub-simulators being initialized with different starting values and parameters at the start of each iteration. In this way, it is possible to observe the effect of varying these values and parameters on the final output of the system.

Still referring to FIG. 1, the system can be seen to comprise an external optimisation module, or optimiser 102. The optimiser 102 is configured to select the initial starting inputs for each sub-simulator 104-1, 104-2 for each iteration of the co-simulation. To do so, the optimiser may employ an optimisation algorithm designed to identify the input values that yield the best outcome from the co-simulation; for example, the algorithm may be employed to determine a set of input values that optimise the performance of the system as measured by the value specified in the final output.

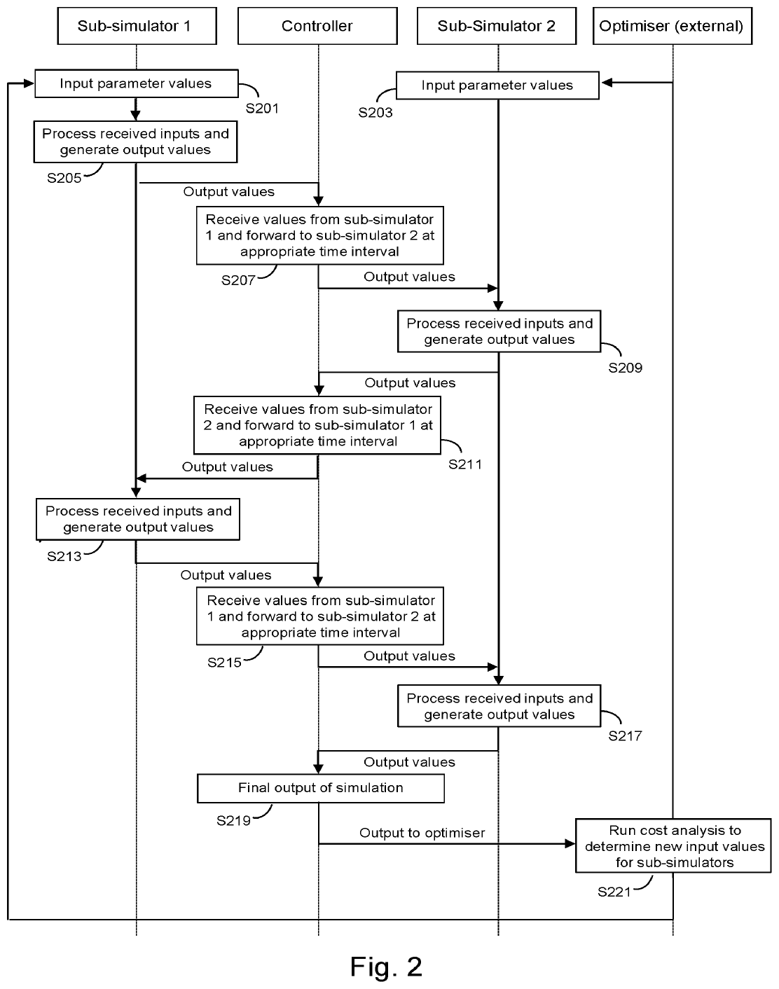

The function of the co-simulator as discussed above can be further understood by reference to FIG. 2, which shows the sequence of operations carried out by the sub-simulators 104-1 and 104-2, the controller 103, and the external optimiser 102.

The process commences in steps S201 and S202, in which the sub-simulators 104-1 and 104-2 receive input values for their sub-simulations. If it is the first iteration of the co-simulation, these input values may be determined by a user, or they may be automatically selected by the optimiser.

In step S205, the first one of the sub-simulators 104-1 uses the received inputs to compute the values for one or more variables in its sub-simulation. The sub-simulator 104-1 may perform these computations iteratively using a numerical method whose step size is pre-selected based on the desired accuracy and/or processing time. Having computed the value(s) for the one or more variables, the first sub-simulator 104-1 outputs those values to the controller. In step S207, the controller provides the received values to the second sub-simulator 104-2, to be used as inputs for calculations performed by the second sub-simulator.

The second sub-simulator 104-2 uses the input values it was provided with at the beginning of the simulation, together with the values it has received from the first sub-simulator 104-1 to compute values for one or more variables in the sub-system being simulated by the second sub-simulator 104-2. In the same way as for the first sub-simulator, the second sub-simulator may perform its computations iteratively using a numerical method whose step size is pre-selected based on the desired accuracy and/or processing time (step S209). Having arrived at the value(s) of the one or more variables, the second sub-simulator 104-2 outputs those values to the controller.

In step S211, the controller provides the values received from the second sub-simulator to the first sub-simulator 104-1. The process continues to repeat, with steps S213 to S217 replicating steps S205 to S209, respectively. In step S219, having received the latest output from the second sub-simulator 104-2, the controller is able to determine the final output for the simulation (it will be appreciated that whilst FIG. 2 shows the first and second sub-simulators 104-1, 104-2 as having exchanged values three times during the course of an iteration of the overall simulation, in practice the sub-simulators may exchange values an arbitrary number of times, as determined by the nature of the system being simulated).

With the output of the current iteration having been obtained in step S219, this output is forwarded to the (external) optimiser. The external optimiser receives the co-output, and performs a cost analysis to determine a revised set of input values for use in the next iteration of the co-simulation. The improved set of input values may be determined by use of an optimisation algorithm, such as an evolutionary algorithm, or a Bayesian algorithm. These input values are provided to the first and second sub-simulators 104-1, 104-2, to be used in the next iteration of the co-simulation.

In some examples, the co-simulation may be configured to repeat (i.e. perform successive iterations) until the output from the co-simulation ceases to converge any further. Alternatively, the co-simulation may continue to iterate for a predetermined length of time, thereby preventing the co-simulation from running indefinitely in the event of convergence being unattainable, or from running for too long if computation of the intermediate results in each iteration takes longer than anticipated.

A problem with the co-simulation system shown in FIGS. 1 and 2 is that the optimiser cannot influence the co-simulation during the course of each iteration. In this sense, the co-simulation is treated as a “black-box” by the optimiser 102; the optimiser must wait until the particular iteration is complete before it is able to affect the execution of the co-simulation by varying the input values.

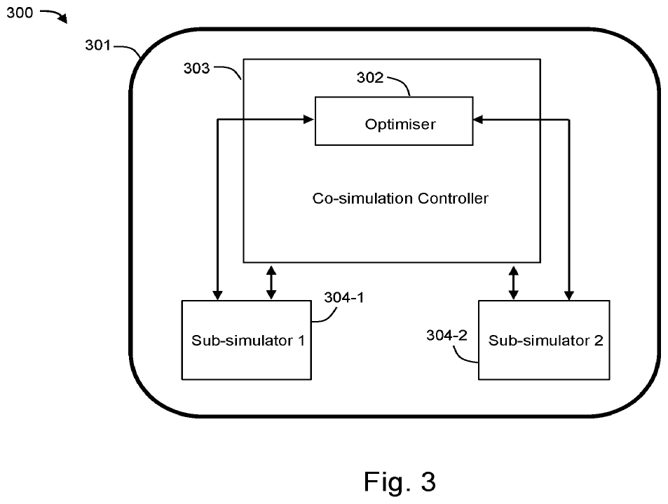

Embodiments described herein provide a solution to the above problem by incorporating the optimiser within the co-simulation. FIG. 3 shows an example arrangement according to an embodiment. It can be seen that, in comparison to FIG. 1, the optimiser 302 has now been integrated into the co-simulation controller 303. Where previously the co-simulation behaved as a black-box from the perspective of the optimiser, the present arrangement allows the optimiser the ability to control the parameters of the co-simulation during individual iterations of the co-simulation.

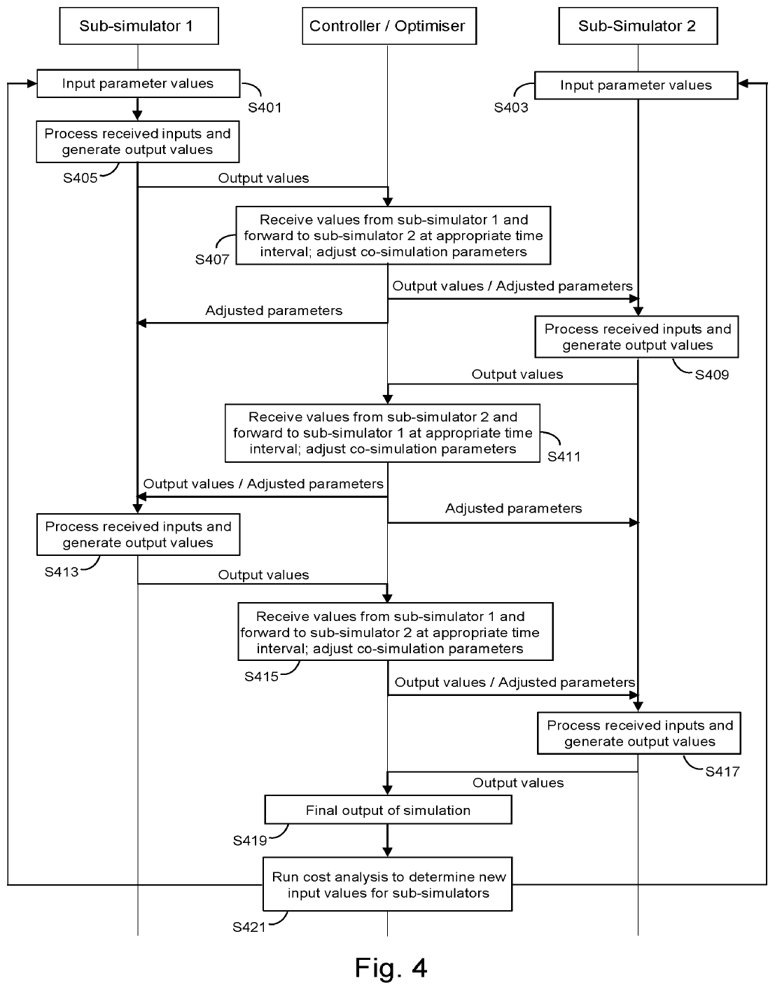

The function of the controller/optimiser shown in FIG. 3 can be further understood with reference to FIG. 4, which shows an example sequence of actions carried out by the different components of FIG. 3. It will be noted that in FIG. 4, the optimiser is combined with the controller, rather than being an external element of the system as in FIG. 2.

As before, the sequence of steps commences with steps S401, S403 in which the sub-simulators 304-1, 304-2 as shown in FIG. 3 receive the input values for their sub-simulations. If it is the first iteration of the co-simulation, these input values may be determined by a user, or they may be automatically selected by the optimiser. In step S405, the first one of the sub-simulators 304-1 uses the received inputs to compute the values for one or more variables in its sub-simulation. The sub-simulator 304-1 may perform these computations iteratively using a numerical method whose step size is pre-selected based on the desired accuracy and/or processing time. Having computed the value(s) for the one or more variables, the first sub-simulator 304-1 outputs those values as intermediate results to the controller and the optimiser.

In step S407, the controller provides the intermediate results it has received from the first sub-simulator 304-1 to the second sub-simulator 304-2, to be used as inputs for calculations performed by the second sub-simulator. At the same time, the optimiser determines whether to adjust one or more elements of the co-simulator in order to optimise the overall simulation.

The optimiser may adjust the co-simulator in one of a number of different ways. In one example, the optimiser may determine that the first sub-simulator is taking too long to compute the intermediate results, and in doing so is slowing down the overall co-simulation. The optimiser may address this by re-configuring the model being run by the sub-simulator, such that it will issue the intermediate results more quickly. In the event that the model is one that uses an iterative method to compute results, for example, the optimiser may reduce the extent to which the results of each iteration of the model are required to converge before being output to the controller. Where the model is being used to determine how values of particular variables evolve over time, the optimiser may increase the time step used in successive iterations of the model, such that a less granular, and possibly less accurate, approach is employed by the sub-simulator, but one which will nevertheless arrive at an output in a shorter period of time. In some embodiments, the optimiser may configure the sub-simulator to switch to an entirely different model for computing the required variables. Alternatively, or in addition, the optimiser may issue a request for more memory to be assigned to the sub-simulator in question, to advance its processing capability.

In a further embodiment, the optimiser may determine, based on the results received from the sub-simulator, that it is not worth continuing with the present iteration of the co-simulation. The optimiser may determine, for example, that the results lie outside of an allowable range of values; this would include the case where the sub-simulator fails to return one or more actual values, but instead returns an error message or other output suggesting that the model cannot be run successfully if using that particular set of input values. The optimiser may determine that the set of input values chosen for the current iteration of the co-simulation lead to results that would either be impractical or which would fail to satisfy safety regulations in the event they were actually implemented in the real-world system being simulated. The optimiser may determine that the values computed by the first sub-simulator are incompatible with the sub-system being simulated by the second sub-simulator. In such cases, the optimiser may issue an instruction to abandon the present iteration of the co-simulation. The optimiser may further issue an instruction to start a new iteration with a different set of input values.

It will be appreciated that the steps described above would not be possible in the conventional co-simulation shown in FIG. 2, since the optimiser would have to wait until the completion of the entire co-simulation before it had any access to information about the co-simulation, and so alterations to the operation of the co-simulation would only be possible for the next instance of co-simulation.

Having determined the adjustments to be made to the model(s) (if any), the optimiser communicates the adjustments to the relevant sub-simulator(s), which are updated accordingly. In the event the optimiser determines that the present iteration is to be cancelled, the co-simulation is either halted or returns to steps S401, S403 with a revised set of input values being selected for the sub-simulators to commence a new iteration of the co-simulation. Assuming that the present iteration is allowed to continue running, the method proceeds to step S409 in which the second sub-simulator uses the input values it was provided with at the beginning of the simulation, together with the values it has received from the first sub-simulator 304-1, to compute values for one or more variables in the sub-system being simulated by the second sub-simulator 304-2. In the same way as for the first sub-simulator, the second sub-simulator may perform its computations iteratively using a numerical method whose step size is pre-selected based on the desired accuracy and/or processing time. Having arrived at the value(s) of the one or more variables, the second sub-simulator 304-2 outputs those values to the controller/optimiser.

In step S411, the controller provides the intermediate results it has received from the second sub-simulator 304-2 to the first sub-simulator 304-1, to be used as inputs for further calculations performed by the first sub-simulator 304-1. At the same time, based on the intermediate results received from the second sub-simulator 304-2, the optimiser determines whether to adjust one or more elements of the co-simulator in order to optimise the overall simulation. Here, the optimiser may take similar steps to those discussed above in step S407.

Again, assuming that the optimiser does not signal for the present iteration to cease, the process repeats, with steps S413 to S417 replicating steps S405 to S409, respectively. In step S419, having received the latest output from the second sub-simulator 304-2, the controller is able to determine the final output for the simulation (it will be appreciated that whilst FIG. 4 shows the first and second sub-simulators 304-1, 304-2 as having exchanged values three times during the course of an iteration of the overall simulation, in practice the sub-simulators may exchange values an arbitrary number of times, as determined by the nature of the system being simulated).

Accordingly, by incorporating the optimiser 302 inside the co-simulation, the optimiser is able to analyse the behaviour of the co-simulation during each individual iteration of the co-simulation and in turn make changes to the co-simulation that can assist in improving the performance and efficiency of the co-simulator. For example, it may be that a set of inputs are completely incompatible with the optimisation of one of the output values. Rather than having to wait until completion of the co-simulation to learn this, the co-simulator of the present embodiment will be able to determine that these values are unsuitable at a much earlier stage and take steps to prevent unnecessary use of computing time and power.

Still referring to FIG. 4, with the output of the current iteration having been obtained in step S419, this output is now used by the optimiser to perform a cost analysis to determine a revised set of input values for use in the next iteration of the co-simulation.

As in FIGS. 1 and 2, the optimiser may use one of several optimisation algorithms, such as an evolutionary algorithm, or a Bayesian algorithm, to determine the revised input values. The optimiser may select the most suitable optimisation algorithm based on its knowledge of the various sub-systems and their respective simulation models. In some embodiments, the optimisation algorithm may be selected based at least in part on user input.

It will be appreciated here that the optimisation as carried out in step S421 is a distinct process from the adjustments carried out by the optimiser upon receiving the intermediate results from the various sub-simulators. In contrast to those adjustments, which seek to optimise the functioning of the respective sub-simulator models and the interplay between them, the optimisation performed in step S421 is designed to identify a set of one or more input parameters for the simulation that will yield the best outcome in terms of the final output from the co-simulation. For example, the co-simulator may seek to optimise one or more of the cost, performance, stability, of the system, with the output of the co-simulation providing an indication of the extent to which these requirements are met for different sets of input values. In this respect, the optimisation algorithm employed in step S421 can help to identify the set of input values for which one or more properties of the system are optimised, whilst the adjustments performed by the optimiser during the course of the individual iterations of the co-simulation can make the process of running each iteration more efficient and forestall unnecessary computation by ruling out particular sets of input values as being non-optimal at an earlier stage in the process.

The optimisation algorithm employed by the optimiser may vary dynamically over the course of the co-simulation. For example, some of the sub-systems might use a simple simulation model during normal operating conditions. However in extreme conditions, a different/more accurate model might be needed which would change the run time for each iteration of the co-simulation. For instance, if a more accurate model is employed for one of the sub-systems that takes longer to compute, the optimisation algorithm employed in step S421 may be adjusted so that it requires fewer evaluations i.e. fewer iterations of the overall co-simulation. In such cases, the co-simulator may transfer the current state of the old optimisation algorithm to the new one to avoid a “cold start”.

In some instances, certain sub-systems might employ simulation models that are less accurate than others; if the co-simulator knows this, it can choose a different optimisation algorithm or change the parameters of the current one. For instance, if there's hardware-in-the-loop, there might be measurement noise which could be quantified. In other cases, as described above, some sub-simulations might require a lot of memory to process particular sets of input values. To accommodate this, the optimiser may switch to an alternative optimisation method or change the parameters of the current one.

Embodiments as described herein may be utilised for the purpose of design automation. When designing a product, the co-simulation may determine the optimal configuration of design parameters in one or more of the sub-systems for the purpose of optimising one or more of the properties of the system, and provide them to the user for manufacturing. Embodiments may also be worked for determining how existing systems would behave under a range of different circumstances, for the purposes of optimising the operation of the existing system.

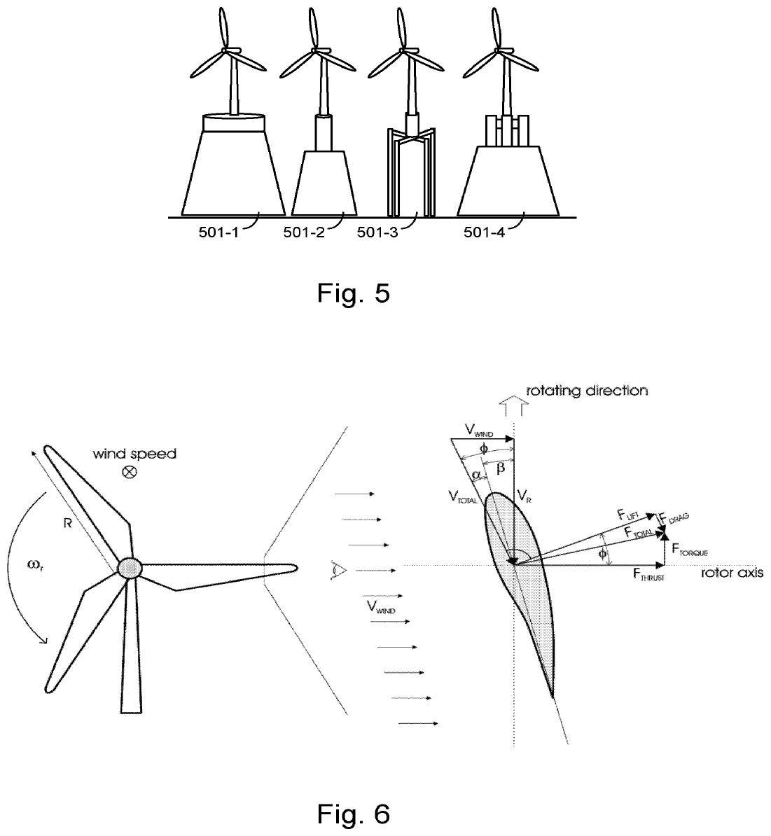

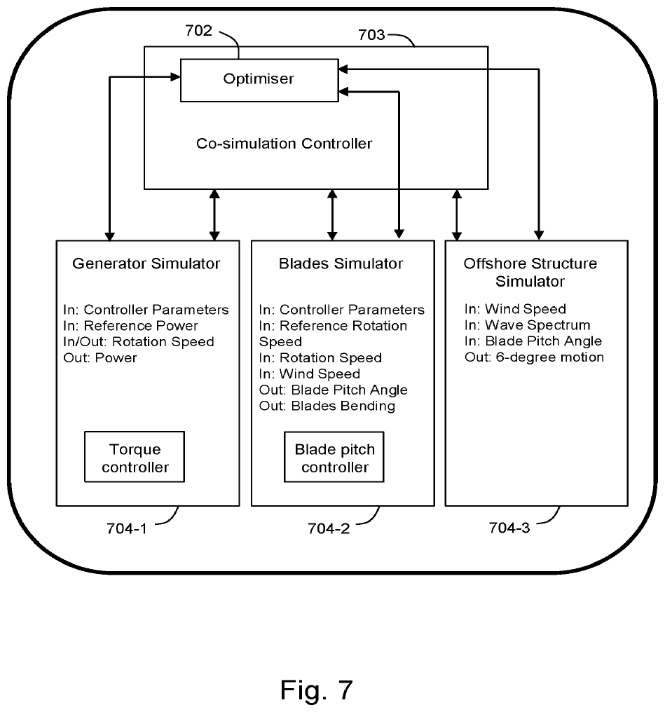

An example co-simulator that embodies the concepts discussed above will now be described with reference to FIGS. 5 to 7. In this example, the co-simulator is used to optimise the design and/or operation of an offshore wind turbine. FIG. 5 shows different types of floating structures 501-1, 501-2, 501-3, 501-4 for an offshore wind turbine, whilst FIG. 6 shows a plurality of blade control parameters that may be adjusted in order to optimise the power output from the turbine. FIG. 7 shows a schematic of a co-simulator for use in simulating the function of the wind turbine.

Referring to FIG. 7, the co-simulator 701 comprises a co-simulation controller 701 and optimiser 703, and three independent sub-simulators 704-1, 704-2, and 704-3, representing sub-systems of the offshore turbine. In this embodiment, the sub-simulator 704-1 is used to simulate a power generator, sub-simulator 704-2 simulates the blades of the turbine, and sub-simulator 704-3 simulates the physical structure on which the turbine is based.

The sub-simulator 704-1 is primarily concerned with simulation of power generation by the generator. During the course of each co-simulation, the sub-simulator 704-1 receives, from the co-simulation controller, input values defining the rotation speed of the blades, and the reference power of the system. At the beginning of the co-simulation, these values may be initialized by a user, or they may be automatically selected by the co-simulation controller/optimiser. The generator sub-simulator 704-1 also includes a torque controller, for the purpose of modelling how changes to the torque affect the power generation. As changes to the torque would also affect the rotation speed of the turbine, the rotation speed may also be an output at a communication point for use in the other sub-simulators, along with the determined power output.

The blade sub-simulator 704-2 may include a blade pitch controller, for the purposes of modelling the effect of changing the blade pitch on the behaviour of the blades. The behaviour of the blades may be output at a communication point, in the form of one or more output values, representing for example the determined rotation speed, blade pitch angle, and degree of bending of the blades.

The sub-simulator 704-3 representing the offshore structure receives as input, data representing the wind speed, wave spectrum, and blade pitch angle. The sub-simulator 704-3 uses these as inputs to compute the 6-degree motion of the structure in time. This 6-degree motion may then be provided to the co-simulation controller at a communication point.

As an example of the exchange of input/output values between the sub-simulators, as the co-simulation progresses, the off-shore structure simulator 704-3 receives input values for the blade pitch angle from the blades sub-simulator 704-2, again via the co-simulation controller. The blades sub-simulator 704-2 computes the blade pitch angle as an intermediate result during the course of each iteration of the co-simulation. The off-shore structure sub-simulator 704-3 then uses the values received from the blades sub-simulator 704-2 for calculating the 6-degree motion of the offshore structure.

As discussed above, when receiving the blade pitch angle from the blades sub-simulator, the controller/optimiser may assess whether the computed pitch angle is in line with accepted bounds, and further whether the blade sub-simulator is able to output the computation of the pitch angle in an acceptable time frame. In the event one or other of these criteria is not satisfied, the optimiser may issue instructions to adjust one or more parameters of the blade sub-simulator and/or bring the present iteration of the co-simulation to an end, before initializing a new iteration of the co-simulation with a new set of starting values for the different sub-simulators.

It will be appreciated that some of the inputs shown in FIG. 7, such as wind speed and wave spectrum, are operating conditions for the system and only impact upon it, and changes to these may not be calculated by the sub-simulators. These operating conditions may be set as constants by the co-simulation controller, or may be made to vary in time for the purpose of simulating the response of the system to changing conditions. Other inputs, such as the rotation speed and the amount of power generated comprise variables whose values may be calculated by one or more of the sub-simulators. The behaviour of these variables may be subject to simulation by more than one sub-simulator, hence requiring the communication between the sub-simulators via the co-simulation controller to ensure uniformity of the behaviour of the variables between the different subsystems.

The co-simulation may be configured such that the generated power and stability of the floating platform are designated as outputs for optimisation. The generated power is an output of the generator sub-simulator, and the stability may be determined from the output of the 6-degree motion from the offshore structure sub-simulator. It may be that it is not possible to optimise most of these outputs simultaneously; for example, a configuration may exist where the power generation is maximised but the structure is unstable, leaving the turbine vulnerable to changes in the wind speed or the wave spectrum. Likewise, a different configuration may exist where the structure is highly stable, but as a result the power generation is limited. In this case, a multi-objective optimisation algorithm may be used to find a configuration for the wind turbine structure that achieves the optimal trade-off between these outputs.

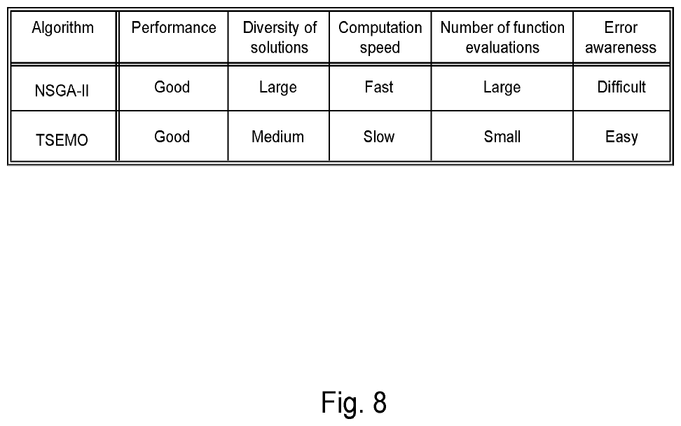

Two example optimisation algorithms are Nondominated Sorted Genetic Algorithm (NSGA) II, and Thompson Sampling Efficient Multiobjective Optimisation (TSEMO). NSGA-II is an example of an evolutionary algorithm, and TSEMO is an example of a Bayesian algorithm. Both algorithms have different strengths and weaknesses, which the optimisation module may be aware of when choosing an algorithm for use. FIG. 8 shows a table summarising the properties of these two algorithms.

In most cases, NSGA-II shows good performance, large diversity of solutions, and fast computational speed. However, NSGA-II requires the performance of a large number of function evaluations, and has little capacity for handling error in the calculations or measurements. In comparison, TSEMO tends to have a smaller diversity of solutions, and is slower computationally, but requires fewer function evaluations and is capable of incorporating known inaccuracies when optimising. Hence, it can be seen that the co-simulation may have reasons to use both algorithms, depending on the circumstances.

During optimisation, the cost functions need to be evaluated multiple times, with different input values. At the beginning of optimisation, the sub-simulations may compute quickly and with relatively little noise, as they may be operating within the scope of what may be considered normal operating conditions. However, as the simulation progresses, the operating conditions may approach the boundaries of normal operating conditions, and may start to simulate abnormal operating conditions. As discussed above, this may require the use of a different model for simulation, such as a more accurate model.

In this scenario, it may be most efficient to start optimisation with NSGA-II, before switching to TSEMO when evaluation time of the sub-simulations has grown larger. So as not to render the NSGA-II optimisation process wasted, the current information gained by NSGA-II can be converted into the format used by TSEMO. This may involve, for example, converting the population members currently present in NSGA-II into the sampling of TSEMO, from which the probability distribution can be constructed. Since members of the Bayesian optimisation family of algorithms, such as TSEMO, are designed for computationally expensive systems, this may prove to be more computationally efficient than continuing to perform NSGA-II function evaluations on the subsimulators.

Another factor that may affect the selection of optimisation algorithm is the accuracy level of the subsimulators. As discussed above, inaccuracy may arise in use of hardware in subsimulators, such as measurement noise, or in errors or approximations present in the models used in the subsimulators. Evolutionary algorithms assume that the functions produce error free results, so it is difficult to accommodate the inaccuracy. By contrast, Bayesian optimisation algorithms can handle inaccuracy, as the variance of the prior probability distribution can be adjusted to incorporate it. Therefore, if the optimisation module is aware that one of the subsimulators is operating with some level of inaccuracy, such as measurement noise, it may select a Bayesian method such as TSEMO to account for this.

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

While certain embodiments have been described, these embodiments have been presented by way of example only and are not intended to limit the scope of the invention. Indeed, the novel methods, devices and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

1. A system for controlling the operation of a co-simulator comprising two or more sub-simulators, each sub-simulator being configured to simulate the behaviour of a respective sub-system of a second system, the co-simulator being configured to perform one or more iterations of a simulation in which the output of the sub-simulators is combined to determine a value of one or more properties of the second system, the system comprising:
a controller configured to receive, at one or more time points during each iteration of the simulation, results of intermediate calculations performed by one or more of the sub-simulators, and to coordinate the input of the received results into other(s) of the sub-simulators for use in subsequent calculations to be performed during the course of the iteration; and
an optimiser configured to determine, at each of the one or more time points and based on the results of the intermediate calculations, one or more elements of the co-simulator to adjust so as to optimise the process of determining the value of the one or more properties of the second system.

2. A system according to claim 1, wherein the one or more sub-simulators simulate the behaviour of the respective sub-systems by executing respective models, and the one or more elements of the co-simulator comprise one or more parameters of at least one of the models.

3. A system according to claim 2, wherein the optimiser is configured to adjust the parameters of at least one of the models, such that the model can be executed more quickly by the respective sub-simulator.

4. A system according to claim 1, wherein the one or more elements of the co-simulator comprise an interval at which the intermediate results are output to the controller by the one or more sub-simulators.

5. A system according to claim 1, wherein the optimiser is configured to abort a current iteration of the simulation based on determining that one or more of the intermediate results lie outside a predetermined range of values.

6. A system according to claim 1, wherein the value of one or more properties of the second system comprises a measure of performance of the second system.

7. A system according to claim 1, wherein for each iteration of the simulation, the two or sub-simulators are provided with one or more input values; and
the optimiser is configured to determine, based on the estimated value of the one or more properties of the second system, a revised set of input values to use in the next iteration.

8. A system according to claim 7, wherein the revised set of input values is determined using an optimisation algorithm, the optimisation algorithm being such as to determine a set of input values that result in an optimal value for the one or more properties of the second system.

9. A system according to claim 8, wherein the co-simulator is configured to determine values of two or more properties of the second system and the optimisation algorithm is selected so as to determine a set of input values that will jointly optimise the values of the two or more properties of the second system.

10. A system according to claim 8, wherein the optimiser is configured to switch to using an alternative optimisation algorithm during the course of the co-simulator performing multiple iterations of the simulation.

11. A system according to claim 10, wherein the optimiser is configured to switch to using the alternative optimisation algorithm in response to adjusting the one or more elements of the co-simulator.

12. A system according to claim 10, wherein upon switching to using the alternative optimisation algorithm, the optimiser is configured to retain, as input for the next iteration of the simulation, the set of input values determined in the latest iteration of the simulation.

13. A system according to claim 8, wherein the optimisation algorithm is selected based on one or more properties of at least one of the two or more sub-simulators.

14. A system according to claim 13, wherein:
the one or more sub-simulators simulate the behaviour of the respective sub-systems by executing respective models;
the one or more elements of the co-simulator comprise one or more parameters of at least one of the models; and
the optimisation algorithm is selected based on the one or more parameters.

15. A system according to claim 13, wherein the optimisation algorithm is selected based on an accuracy or noise level associated with one or more of the sub-simulators.

16. A system according to claim 15, wherein the accuracy of each sub-simulator is defined based on a difference between results of calculations for variables output by the sub-simulator and expected values for the variables in the real world.

17. A system according to claim 13, wherein the optimisation algorithm is selected based on a memory requirement of the one or more of the sub-simulators.

18. A system according to claim 1, wherein the second system is a windmill.

19. A method for managing the operation of a co-simulator comprising two or more sub-simulators, each sub-simulator being configured to simulate the behaviour of a respective sub-system of a system, the co-simulator being configured to perform one or more iterations of a simulation in which the output of the sub-simulators is combined to determine a value of one or more properties of the system, the method comprising:
receiving, at one or more time points during each iteration of the simulation, results of intermediate calculations performed by one or more of the sub-simulators;
coordinating the input of the received results into other(s) of the sub-simulators for use in subsequent calculations to be performed during the course of the iteration; and
determining, at each of the one or more time points and based on the results of the intermediate calculations, one or more elements of the co-simulator to adjust so as to optimise the process of determining the value of the one or more properties of the system.

20. A non-transitory computer-readable storage medium comprising computer executable instructions that when executed by a computer will cause the computer to carry out a method according to claim 19.
